(19) United States
(12) Patent Application Publication
(10) Pub. No.: US 2023/0038435 A1
(43) Pub. Date: Feb. 9, 2023

(54) METHOD AND APPARATUS FOR DETERMINING THE SIZE OF DEFECTS DURING A SURFACE MODIFICATION PROCESS

(71) Applicant: Ford Global Technologies, LLC, Dearborn, MI (US)

(72) Inventors: David Mark Newton, Köln (DE); Michael Herbert Oelscher, Bergheim (DE); Jonas Bachmann, Köln (DE); Philipp Butz, Hürth (DE)

(73) Assignee: Ford Global Technologies, LLC, Dearborn, MI (US)

(21) Appl. No.: 17/878,383

(22) Filed: Aug. 1, 2022

(30) Foreign Application Priority Data
Aug. 5, 2021 (DE) 102021120435.6

(51) Int. Cl. B23K 31/12; B23K 31/00; G06T 7/00; B23K 26/03

(52) U.S. Cl. CPC B23K 31/125; B23K 31/006; G06T 7/0008; B23K 26/032; G06T 2207/30164

(57) ABSTRACT

A method is specified for determining a size of a defect occurring in a surface region of a component while a surface modification process is performed on the surface region. The method includes identifying an occurrence of a defect occurring in a surface region of a component on a basis of a set of images and determining a size of the defect in a separate method step from the occurrence of the defect identified. In addition, an apparatus and a computer program are specified for determining a size of a defect occurring in a surface region of a component while a surface modification process is performed on the surface region.

### CROSS-REFERENCE TO RELATED APPLICATIONS

This application claims priority to and the benefit of German Patent Application No. 102021120435.6, filed on Aug. 5, 2021. The disclosure of the above application is incorporated herein by reference.

### FIELD

The present disclosure relates to a computer-implemented method, an apparatus, and a computer program for determining a size of a defect occurring in a surface region of a component while a surface modification process is performed on the surface region.

### BACKGROUND

The statements in this section merely provide background information related to the present disclosure and may not constitute prior art.

Laser beam brazing is a well-known joining process. In the automotive sector, laser beam brazing is used, for example, for joining galvanized steel sheets in the mass production of automotive bodies, e.g., for connecting the roof to the side panels or for joining a two-part tailgate outer panel. Here, a laser beam is guided along the joint, wherein it melts a filler material, e.g., a copper-silicon wire, which connects together the components to be joined as they cool. Compared to other joining processes, laser beam brazing has the advantage that joint connections can be produced with both high strength and high aesthetic surface quality.

Another well-known joining process is laser beam welding, e.g., for joining lightweight aluminum components using a weld wire.

The surface quality aspect is of particular importance in terms of customer satisfaction in these joining processes. Consequently, quality control of all soldered and/or welded points is required. By default, this is done by means of manual visual inspection. However, such inspection is very labor-intensive. Efforts are therefore underway to automate the quality assurance process.

Automated quality assurance procedures are known, for example, from the field of laser beam welding. For example, German Patent Application 11201000340.6 T5 discloses a method for determining the quality of a weld, in which an image of the weld section is acquired with a high-speed camera. In the acquired image, the presence of parameters such as the number of welding spatters per unit length is examined. The weld quality is assessed by comparing the analyzed parameter with a previously compiled comparison table. This method presupposes that appropriate, meaningful quality parameters can be found. In addition, compiling a sufficiently accurate comparison table is very laborious and requires a large number of previously determined data sets that reflect a correlation between the quality parameter and the actual quality.

A further quality assurance method used for laser beam welding of pipes is known from U.S. Pub. No. 2016/0203596 A1. Here, a camera is positioned on the side facing away from the laser, e.g., inside the pipe, by means of which images of the joint are recorded. The number of defects is determined by means of an image evaluation, which comprises an assignment of brightness values to image pixels. However, this method can only be used for joining methods that enable image acquisition from the side facing away from the laser and in which the brightness evaluation described allows the presence of defects to be identified. Due to its inaccuracy, this method is not suitable for very high-quality surfaces.

A higher accuracy can be achieved with the method described in U.S. Pub. No. 2015/0001196 A1, which uses a neural network for the image analysis. An image of a finished welded joint is acquired. A classification of the image, and therefore the weld seam, as normal or defective can be performed by means of a neural network, wherein the accuracy of the classification can be varied by means of the properties of the neural network.

Further defect detection and characterization methods are known from Chinese Patent Application 109447941 A, Chinese Patent Application 110047073 A, and U.S. Pub. No. 2017/0028512 A1.

However, the classification as normal or defective does not allow a more accurate assessment of the defect, which would be desirable since very small defects can be corrected in subsequent processing steps, such as grinding or polishing. Major defects, on the other hand, are not easily correctable with sufficient surface quality, but require more complex repair or even replacement of the affected component.

A method for detecting machining errors of a laser machining system with the aid of deep convolutional neural networks is known from WO 2020/104102 A1. The following information or data can be obtained as an output tensor: whether there is at least one machining error present, the type of machining error, the position of the machining error on the surface of the processed workpiece, and/or the size or extent of the machining error. The deep convolutional neural network can use a so-called “You Only Look Once” style (YOLO-style) method to enable the detection and localization of machining errors with an indication of the size of the machining errors. Object detection, i.e., defect detection and determination of the defect size, are carried out jointly in one processing step, i.e., defect detection and size determination are performed at the same time for each image. This limits the speed of the overall process.

Therefore, this method can only be used for joining processes with high component throughput to a limited extent or with considerably greater complexity in the required camera and computer technology. In other words, this method is very computationally intensive, so that a large amount of computing power would be required to process high frame rates in real time. Conversely, the maximum frame rate that can be processed in real time is very limited.

A defect detection method is also known from Chinese Patent Application 109977948 A, which uses a YOLO algorithm.

The present disclosure addresses these issues related to determining a size of welding defects for example in steel and aluminum structures, among other types of materials.

### SUMMARY

This section provides a general summary of the disclosure and is not a comprehensive disclosure of its full scope or all of its features.

In one form, the present disclosure specifies a method and an apparatus with which the size of defects occurring during a surface modification process can be determined quickly and with high accuracy with the minimum possible effort.

A first aspect of the disclosure relates to a computer-implemented method for determining a size of a defect occurring in a surface region of a component while a surface modification process of that surface region is performed. The method includes: identifying the occurrence of a defect on a basis of a set of images and determining a defect size in a separate method step from the identification of the defect occurrence.

Computer-implemented means that at least one method step, in one form a plurality or all of the method steps, are executed using a computer program.

On the basis of images means that the occurrence or non-occurrence of a defect is determined by evaluating recorded images of the surface region to be inspected, by evaluating images of the surface region to be assessed in a computer-implemented manner.

A surface modification process is understood to mean a process that leads to a temporary or permanent change at least in the surface of the component, so that an effect of the surface modification process can be assessed on the basis of recorded images of the treated surface region of the component. Examples of surface modification processes can include: joining processes such as soldering processes, in particular laser-beam soldering processes, welding processes, in particular laser-beam welding processes, adhesive bonding processes or surface treatment processes such as coating processes, 3D printing processes, plasma treatment processes, cleaning processes, etcetera. The surface modification process can in one form be used in the automotive industry.

Defect identification means identifying an occurrence of a defect, means that it is detected whether or not there is a defect present in the surface region concerned. In other words, the surface region to be evaluated or the corresponding component can be classified as “defective” or “not defective”.

Size determination means determining the size of the defect, means that the defect is classified according to its size. In one form, two or more size classes can be defined, into which the surface region to be evaluated or the corresponding component is grouped or classified. The number and characteristics of the size classes can be determined depending on the surface modification process and the specific application. In one form, the size classes may be defined in such a way that surface regions grouped into a first size class have a defect that is repairable due to its small size, while surface regions grouped into a second size class have a defect that cannot be repaired due to its large size.

The size determination is also carried out in a computer-implemented manner by evaluating recorded images or pictures of the surface region having the previously detected defect.

Commonly used image processing methods and object detection algorithms can be used for both defect identification and size determination.

The method can be used not only to identify surface defects in the surface region of the component that occur during the surface modification process, e.g., spatter, holes, cracks, etcetera, but their size can also be determined. The surface defects can advantageously be identified during the surface modification process, i.e., in real time, and in situ so that the corresponding components can be quickly identified as defective and, in one form, reprocessed or rejected.

By carrying out the defect identification and the size determination separately from each other, the size determination can be completed quickly and with high accuracy with little effort, in particular with regard to computational resources. This allows the identification of defects to be carried out with a high throughput of components to be inspected, e.g., by using a high-speed camera with a frame rate of at least 100 frames per second. The size determination to be carried out separately from this can then be carried out at a lower speed without reducing the throughput, as only those components for which a defect was previously determined are fed into the size determination.

On the other hand, a combined implementation of defect and size determination with manageable effort requires a significantly lower throughput of components to be inspected, due to the increased time required. Such a method is therefore not suitable for the quality assurance of joining processes with high component throughput, e.g., in the automotive industry.

The computer-implemented execution of the method means that reducing a number of personnel for visually inspecting the components, thus reducing costs and providing quality standards that can be reliably adhered to by eliminating the subjective component of the inspector. It also enables automation of the quality assurance process.

The process is suitable for all types of components that can undergo a surface modification process, e.g., metal, glass, ceramic, or plastic components. This also includes components created by joining separate parts.

According to various design variants, the size of the defect can be determined by means of a YOLO-style model (“You Only Look Once” model). In other words, a YOLO-style model can be used for the size determination.

The term “YOLO-style model” is used in this description to refer to an object detection algorithm in which the object recognition is represented as a simple regression problem, mapping from image pixels to frame coordinates and class probabilities. In this method, an image is observed only once (YOLO-style—You Only Look Once) to calculate which objects are present in the image and where they are located. A single convolution network simultaneously calculates a plurality of object boundaries or object frames, also known as bounding boxes, and class probabilities for these object frames. The network uses information from the entire image to calculate each individual object frame. In addition, all object frames from all classes for an image are calculated simultaneously. This means that the YOLO-style model creates an overall view for an image and for all objects within it. The YOLO-style model enables real-time processing of images with a high average object recognition accuracy.

An image is divided into an S x S grid. For each grid cell, a number of B object frames of different sizes is calculated, with the associated probability values for object recognition. The probability values indicate the certainty with which the model recognizes an object in an object frame and how exactly the object frame is placed around the object. In addition, a class membership is calculated for each grid cell. The combination of the object frames and the class membership allows objects in the image to be detected and their size to be determined from the object frames. With the aid of the YOLO-style model, surface defects can thus be determined in terms of their position and size.

For more information on a YOLO-style model, refer to REDMON, J. et al. You Only Look Once: Unified, Real-Time Object Detection, arXiv:1506.02640v5 [cs.CV] 9 May 2016.

According to other design variants, the occurrence of the defect can be detected using the following method steps: providing an image sequence comprising a plurality of image frames of a surface region to be evaluated, each image frame showing an image section of the surface region and with the image sections of the image frames at least partially overlapping, assigning the image frames to at least two image classes, of which at least one image class has the attribute ‘defective’, hereafter referred to as the defect image class, checking whether multiple image frames of a specifiable number of directly consecutive image frames in the image sequence have been assigned to the defect image class, and outputting a defect signal if multiple image frames of the specifiable number of directly consecutive image frames have been assigned to the defect image class. In other words, the defect determination can comprise the method steps listed.

In a first method step of this defect identification method, an image sequence of a surface region of the component to be evaluated is provided. In one form, the image sequence can be retrieved from a storage medium or transferred directly from a camera recording the image sequence. Direct transmission advantageously makes it possible to perform a real-time assessment of the occurrence of defects and thus to intervene in the detection of defective components or a defective surface modification device in a timely manner, so that a high rejection rate can be prohibited.

The image sequence comprises a plurality of image frames. Each image frame shows a section of the image of the surface region. The image sections of the individual frames at least partially overlap. This means that an image section of the individual frames is selected in such a way that a surface point of the surface region is mapped in at least two, in one form, and in another form more than two, such as four, directly consecutive image frames. The image section may have been altered by movement of the component and/or the camera recording the image sequence.

In a further method step the image frames are assigned to at least two image classes. At least one of the image classes has the attribute “defective” (i.e., a defective attribute). This image class is also referred to as the “defect image class”. In other words, a plurality, in one form all, of the image frames are classified and assigned to an image class, i.e., either the defect image class or the non-defect image class. Optionally, additional image classes can be formed, e.g., according to the type of defect, in order to enable a more precise characterization of a surface defect. In one form, a distinction can be made according to the type of defect, e.g., pore, spatter, etcetera.

Images can be assigned to the image classes using, in one form, a classification model or a regression model. According to the Encyclopedia of Business Informatics—Online Dictionary; published by Norbert Gronau, Jorg Becker, Natalia Kliewer, Jan Marco Leimeister, Sven Overhage http://www.enzyklopedie-der-wirtschaftsinformatik.de, dated Aug. 7, 2020, a classification model is a mapping that describes the assignment of data objects, in this case the image frames, to predefined classes, in this case the image classes. The class characterization of the discrete classification variables results from the characteristics of the attributes of the data objects. The basis for a classification model is formed by a database, the data objects of which are each assigned to a predefined class. The classification model that is created can then be used to predict the class membership of data objects for which the class membership is not yet known.

With a regression model, a dependent, continuous variable is explained by a number of independent variables. It can therefore also be used to predict the unknown value of the dependent variables using the characteristics of the associated independent variables. The difference with respect to a classification model lies in the cardinality of the dependent variables. A classification model uses a discrete variable, and a regression model uses a continuous variable.

After the image frames have been assigned to the image classes, a further method step is performed to check whether multiple images of a specifiable number of directly consecutive image frames have been assigned to the defect image class. Here, both the number of directly consecutive image frames used and the number of image frames at least assigned to the defect image class can be defined depending on the specific application, e.g., depending on the surface modification process used, the measuring technique used, the desired surface quality, etcetera.

In one form, it can be specified that a check is made as to whether all image frames of the specifiable number of directly consecutive image frames, i.e., in one form, two image frames of two directly consecutive image frames, have been assigned to the defect class. Alternatively, it can be specified, in one form, that a check is carried out to determine whether two, three or four image frames of four directly consecutive image frames have been assigned to the defect class etcetera. In other words, the number of image frames to be checked is less than or equal to the specifiable or specified number of directly consecutive frames.

In a further method step, a defect signal is output if multiple image frames of the specifiable number of directly consecutive image frames in the image sequence have been assigned to the defect image class. The defect signal can be used as a trigger signal to determine the size of the defect. In other words, it is possible to check whether a defect signal exists which is equivalent to the presence of a defect. If this is the case, the size of the defect is determined, in one form using a YOLO-style model, in a subsequent method step. In order to save computing power, the YOLO-style model is only applied to those images that have previously been classified as defective.

In addition, the defect signal can be used, in one form, to interrupt the surface modification process or to send a notification to an operator of the surface modification device carrying out the surface modification process.

By basing the identification of the occurrence of a surface defect not only on one image frame classified as defective but also on the classification of multiple image frames of a specifiable number of directly consecutive image frames, the accuracy of the defect prediction can be significantly increased. In particular, false-positive and false-negative results, i.e., surface regions wrongly assessed as or wrongly assessed as non-defective, can be reduced or even inhibited altogether, because the assessment of a surface region based on an image frame classified as defective is verified on a basis of an image frame immediately following it.

In accordance with other design variants, the method can comprise providing a trained neural network, wherein the image frames are assigned to the image classes by means of the trained neuronal network.

In one form, the classification model described above or the regression model described above can be implemented in the form of a neural network.

A neural network provides a framework for various algorithms for machine learning, for inter-operation, and for processing complex data inputs. Such neural networks learn to perform tasks based on examples without typically having been programmed with task-specific rules.

A neural network is based on a collection of connected units or nodes called artificial neurons. Each connection can transmit a signal from one artificial neuron to another. An artificial neuron that receives a signal can process it and then activate other artificial neurons connected to it.

In conventional implementations of neural networks, the signal at a connection of artificial neurons is a real number, and the output of an artificial neuron is calculated using a non-linear function of the sum of its inputs. The connections of artificial neurons typically have a weight that is adapted as the learning progresses. The weight increases or decreases the strength of the signal at a connection. Artificial neurons can have a threshold, so that a signal is only output if the total signal exceeds this threshold.

Typically, a large number of artificial neurons are combined in layers. Different layers might perform different types of transformations on their inputs. Signals migrate from the first layer, the input layer, to the final layer, the output layer, possibly after several passes through the layers.

The architecture of an artificial neural network can be similar to a multi-layer perceptron network. A multi-layer perceptron network belongs to the family of artificial feed-forward neural networks. Essentially, multi-layer perceptron networks consist of at least three layers of neurons: an input layer, an intermediate layer, also known as a hidden layer, and an output layer. This means that all neurons of the network are organized into layers, with a neuron of one layer always being connected to all neurons of the next layer. There are no connections to the previous layer and no connections that skip over a layer. Apart from the input layer, the different layers consist of neurons that are subject to a non-linear activation function and are connected to the neurons of the next layer. A deep neural network can have many such intermediate layers.

Training an artificial neural network means appropriately adjusting the weights of the neurons and, if applicable, threshold values. Essentially, three different forms of learning can be distinguished: supervised learning, unsupervised learning, and reinforcement learning.

In supervised learning, the neural network is presented with a very large number of training data records that pass through the neural network. The desired result of this is known for each training data record, so that a deviation between the actual and the desired result can be determined. This deviation can be expressed as an error function and the goal of the training is to reduce usage of this function. After completion of the training, the trained network is able to show the desired response, even to unknown data records. Consequently, the trained neural network has the ability to transfer information, or to generalize.

In the case of unsupervised learning, however, no specific desired result is known. Rather, the neural network independently attempts to recognize regularities in the data set and to create categories based on them and classify further data records accordingly.

As with unsupervised learning, in reinforcing learning no specific desired outcome is known either. However, there is at least one evaluation function that is used to assess whether an obtained result was good or bad and if so, to what extent. The neural network now strives to maximize this function.

The trained neural network used to assign the image frames to the image classes may have been trained using one of the methods described above. In one form, the training data sets used can contain images of surface regions of a component that are known to show a defect or not and that have been assigned to the defect image class or the non-defect image class. If other image classes are used, images classified according to these other image classes may have been used as training data sets.

Assigning the image frames to the image classes by means of the trained neural network has the advantage that the image frames can be assigned to the respective image class with high accuracy and therefore fewer false-positive or false-negative assignments are obtained. Overall, the accuracy of the surface defect prediction can be further increased.

In one form, the trained neural network may have been trained by means of transfer learning. Transfer learning uses an existing pre-trained neural network and trains it for a specific application. In other words, the pre-trained neural network has already been trained using training data records and thus contains the weights and thresholds that represent the features of these training data records.

The advantage of a pre-trained neural network is that learned features can be transferred to other classification problems. In one form, a neural network trained using very many easily available training data sets with bird images may contain learned features such as edges or horizontal lines that can be transferred to another classification problem that may not relate to birds, but to images with edges and horizontal lines. In order to obtain a neural network that is suitably trained for the actual classification problem, comparatively few further training data records are then desired that relate to the actual classification problem, e.g., the defect recognition described here.

Advantageously, only a small amount of training data specific to the classification problem will therefore be desired to obtain a suitably trained neural network. The desired specific training data can thus be obtained more quickly, so that a classification is possible after only a short time. In addition, classification problems can also be solved for which not enough specific training data sets are available to be able to train a neural network exclusively with domain-specific training data. The use of a pre-trained neural network as a starting point for subsequent training with specific training data sets also has the advantage that less computing power is desired.

The trained neural network can differ from the pre-trained neural network, in one form, in that additional layers, e.g., classification layers, have been added.

In one form, the neural network referred to elsewhere as ResNet50 can be used as the pre-trained neural network. In addition to ResNet50, in one form, ResNet18 can also be used.

To further increase the prediction accuracy, methods such as data augmentation, Gaussian blur, and other machine learning techniques can also be used. In addition, the trained neural network can also be further trained with the image frames acquired as part of the proposed method.

The trained neural network may alternatively or additionally have been trained by means of iterative learning.

This means that the neural network can initially be trained with a small training data set (first iteration loop). With this neural network, which has not yet been perfectly trained, it is already possible to assign first image frames to the defect image class. These can be added to the training data set so that the accuracy can be increased in a second iteration loop. Further iteration loops can follow accordingly.

Iterative learning can advantageously be used to increase the accuracy. On the basis of the first iteration loop, the data generation for further training cycles can also be significantly accelerated.

In accordance with other design variants, the method can include, as a further method step which is carried out before the image sequence is provided, the acquisition of the image sequence comprising the plurality of image frames of the surface region to be evaluated, each image frame showing an image section of the surface region and with the image sections of the image frames at least partially overlapping.

In other words, the image section is selected in such a way that a surface point of the surface region is represented in multiple directly consecutive image frames. The acquired images can then be made available in the next method step for the subsequent method steps, so that reference is made to the above explanations of the provided image sequence.

In one form, the image sequence can be recorded at a frame rate of 100 frames per second. Such a frame rate proves to be advantageous for many surface modification processes, in particular soldering and welding processes, because when the camera is attached to the surface modification device for acquiring the image sequence, a sufficiently large overlap region can be achieved so that potential defects can be detected on multiple image frames of the specifiable number of directly consecutive image frames, in one form, on two frames or in one form more than two directly consecutive frames. On the other hand, the frame rate does not need to be significantly higher than 100 frames per second, so that the acquisition of the images and the real-time evaluation can be carried out with standard computer technology and thus cost-effectively. Even a frame rate lower than 100 frames per second may be sufficient if the advancing movement of the machining process is fairly slow and defects can also be imaged in the image sequence at a lower frame rate.

In general, the minimum frame rate depends on the speed of the surface modification process. The faster the process, the higher the frame rate should be so that an error can be detected on multiple consecutive image frames.

In addition to the frame rate, other parameters can also influence the desired computing power, including such as image resolution (x,y), color information (e.g., RGB or BW), color depth (e.g. 8, 10 or 12 bits per channel), assignment of the image frames to the image classes by means of single precision double precision, etcetera. The size of the model used, e.g., of the trained neural network, is also a determinant to the resources desired on the hardware used.

In accordance with other design variants, the image section can be moved together with a surface modification device for carrying out the surface modification process.

In one form, the surface modification process can be a continuous process in which the image section is shifted as the surface modification progresses. This provides that the surface region currently being processed is always captured by the camera, so that newly occurring surface defects can be identified quickly.

In a laser beam process, in one form a laser beam soldering process or a laser beam welding process, a camera can be used that is oriented coaxially with the processing laser and therefore looks through the processing laser. As a result, the camera moves together with the processing laser. In one form, in a laser soldering process the region selected as the image section can be e.g., part of the soldering wire—processing zone—solidified solder connection, which travels along the surface of the component together with the processing laser.

The advantage of linking the camera to the surface modification device in this way is that the camera is moved automatically, and the image section therefore changes automatically without requiring a separate camera controller.

In one form, the method can be carried out in real time during the surface modification process.

This makes it advantageously possible to quickly identify any surface defects that occur. As a result, if a surface defect is detected, rapid intervention can be taken so that a defective component can be removed and, if necessary, further surface defects can be avoided.

According to other design variants, the YOLO-style model may have been trained with the same training data as the trained neural network.

In other words, a trained YOLO-style model for the size determination can be provided, which has been trained with the same training data as the trained neural network. In this respect, reference is made to the above statements regarding the training of the neural network. This can reduce the effort to obtain training data.

A further aspect of the disclosure relates to an apparatus for determining a size of a defect occurring in a surface region of a component while a surface modification process is performed on that surface region. The apparatus comprises a data processing unit which is designed and configured to detect an occurrence of a defect on a basis of set of images and to determine a size of the defect in a method step separate from the identification of the occurrence of the defect.

The data processing unit may be operatively connected for signal transmission to a memory unit, a camera unit, and/or an output unit and can therefore receive signals from these units and/or transmit signals to these units.

The apparatus can be used, in one form, to carry out one of the above-described methods, i.e., to identify a size of a defect occurring in a surface region of a component while a surface modification process is performed on the surface region. Thus, the advantages of the method according to the disclosure can also be achieved with the apparatus according to the disclosure. All versions with regard to the method according to the disclosure can be transferred analogously to the apparatus according to the disclosure.

According to various design variants, the data processing unit is designed and configured to determine the size of the defect by means of a YOLO-style model. In one form, the YOLO-style model may be stored in a memory unit that is operatively connected to the data processing unit for signal communication.

In accordance with other design variants, the data processing unit for identifying the occurrence of the defect can be designed and configured to assign image frames of an image sequence comprising a plurality of image frames of a surface region to be evaluated to at least two image classes, each image frame showing an image section of the surface region and the image sections of the image frames at least partially overlapping, and wherein at least one image class has the attribute ‘defective’, hereafter referred to as the defect image class, to check whether multiple image frames of a specifiable number of directly consecutive image frames in the image sequence have been assigned to the defect image class, and to output a defect signal if multiple image frames of the specifiable number of directly consecutive image frames have been assigned to the defect image class.

According to different design variants, the data processing unit can have a trained neural network for assigning the image frames to the at least two image classes. In this regard also, reference is made to the above statements regarding the description of the trained neural network and its advantages.

In accordance with other design variants, the apparatus can comprise a camera unit which is designed and configured to record an image sequence comprising a plurality of image frames of the surface region to be evaluated, with each image frame showing an image section of the surface region and the image sections of the image frames at least partially overlapping.

In other words, an image section of the image frames can be selected in such a way that a surface point of the surface region can be imaged in multiple directly consecutive image frames.

In one form, the camera can be a high-speed camera with a frame rate of at least 100 frames per second.

According to other design variants, the apparatus can be a surface modification device, designed for surface modification of the surface region of the component. The surface modification device can be, in one form, a laser soldering device, a laser welding device, a gluing device, a coating device, or a 3D printing device.

In one form, the camera can be mounted directly on the surface modification device, so that whenever the surface modification device or part of the surface modification device moves, the camera moves automatically along with it.

A further aspect of the disclosure relates to a computer program for determining a size of a defect occurring in a surface region of a component while a surface modification process is performed on that surface region. The computer program contains commands which, when the program is executed by a computer (e.g. a computer can include one or more processers and memory for executing the computer program), cause the computer to identify an occurrence of a defect on the basis of images and to determine a size of the defect in a method step separate from the identification of the occurrence of the defect.

In one form, the computer program may comprise commands which, when the program is executed by a computer, cause the computer to determine the size of the defect using a YOLO-style model.

Consequently, the computer program according to the disclosure can be used to carry out one of the above-described methods according to the disclosure, i.e., in one form for determining surface defects and their size, when the computer program is executed on a computer, a data processing unit, or one of the specified devices. Therefore, the advantages of the method according to the disclosure are also achieved with the computer program according to the disclosure. All statements with regard to the method according to the disclosure can be transferred analogously to the computer program according to the disclosure.

A computer program can be defined as a program code that can be stored on a suitable medium and/or retrieved via a suitable medium. For storing the program code any suitable medium for storing software can be used, in one form a non-volatile memory installed in a control unit, a DVD, a USB stick, a flash card, or the like. The program code can be retrieved, in one form, via the internet or an intranet or via another suitable wireless or wired network.

In accordance with various design variants, the commands which when executed on a computer cause the computer to identify the occurrence of the defect, can cause the computer to assign image frames of an image sequence comprising a plurality of image frames of a surface region to be evaluated to at least two image classes, each image frame showing an image section of the surface region and the image sections of the image frames at least partially overlapping, and wherein at least one image class has the attribute ‘defective’, hereafter referred to as the defect image class, to check whether multiple image frames of a specifiable number of directly consecutive image frames in the image sequence have been assigned to the defect image class, and to output a defect signal if multiple image frames of the specifiable number of directly consecutive image frames have been assigned to the defect image class.

The disclosure also provides a computer-readable data carrier on which the computer program is stored, as well as a data carrier signal that transmits the computer program.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

Further advantages of the present disclosure are apparent from the figures and the associated description. In the drawings:

FIG. 1 shows a flow diagram of an example method, according to the teachings of the present disclosure;

FIG. 2 shows a schematic illustration of an example apparatus, according to the teaching of the present disclosure;

FIG. 3 shows one form of an image sequence, according to the teachings of the present disclosure;

FIG. 4 shows another form of the image sequence, according to the teachings of the present disclosure;

FIG. 5 shows still another form of the image sequence, according to the teachings of the present disclosure;

FIG. 6 shows an illustration of the prediction accuracy, according to the teachings of the present disclosure;

FIG. 7a shows a first image frame of two consecutive image frames with an object bounding box for size determination, according to the teachings of the present disclosure; and

FIG. 7b shows a second image frame of the two consecutive image frames, with an object bounding box for size determination, according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

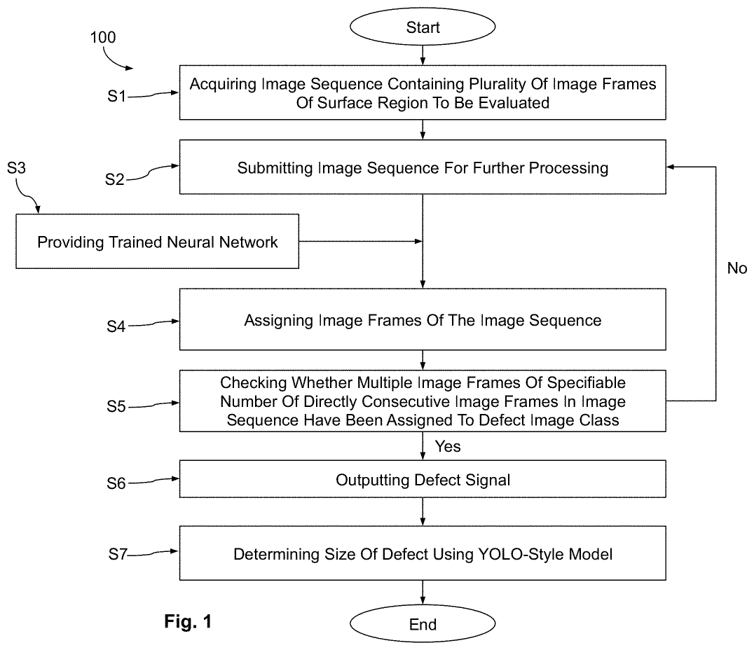

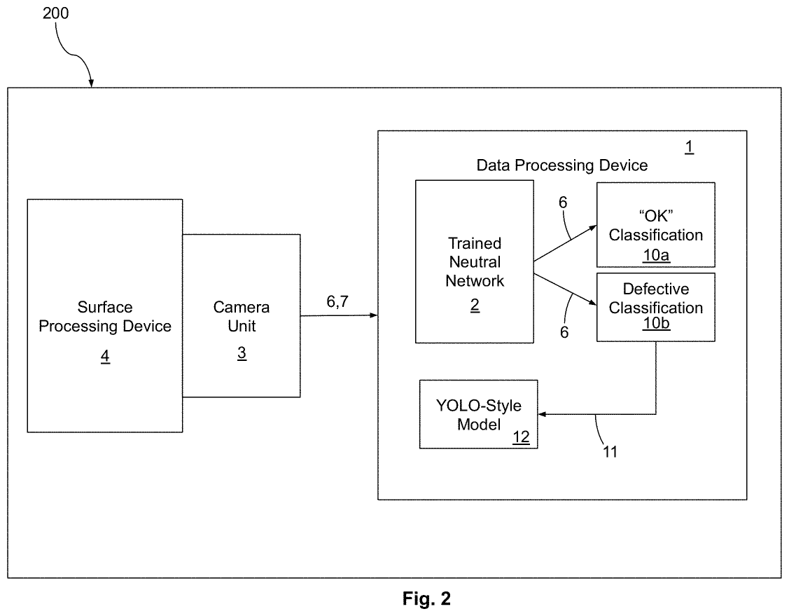

The disclosure is explained in more detail below by reference to FIGS. 1 and 2 based on a laser soldering process and an associated apparatus 200. Therefore, a method 100 and an apparatus 200 are described for identifying defects 7 occurring during the execution of a laser soldering process on a surface region 8 of a component. Specifically, this is a laser brazing process for connecting metal sheets, namely connecting a roof of a passenger car to the associated side panel. However, the disclosure is not limited to this process and can be used analogously for other surface modification processes.

The method 100 is carried out by means of the apparatus 200 shown schematically in FIG. 2. The apparatus 200 comprises a surface modification device 4, which in in one form is a laser soldering device. The laser soldering device is designed and configured to generate a laser beam and emit it in the direction of a surface region 8 to be treated. In addition, the surface region 8 is fed a solder, e.g., in the form of a soldering wire, which is melted by means of the laser beam and used to join the vehicle roof to a side panel.

The apparatus 200 also comprises a camera unit 3. In one form, the camera unit 3 includes a SCeye® process monitoring system manufactured by Scansonic MI GmbH. The camera unit 3 is designed and configured as a coaxial camera and has a laser lighting device, wherein the wavelength of the laser of the laser lighting device differs from the wavelength of the machining laser of the laser soldering device. In one form, a wavelength of approx. 850 nm was selected for the laser lighting device. The camera unit 3 is appropriately sensitive to this wavelength. Due to the wavelength of approx. 850 nm, interference effects from ambient light and other light sources are largely avoided.

The camera unit 3 is arranged with respect to the laser soldering device in such a way that an image sequence 5 in the form of a video can be captured through the processing laser beam. In other words, an image sequence 5 is recorded that consists of a plurality of image frames 6 of the surface region 8 to be evaluated. The image section 9 is selected in such a way that it extends from the end region of the soldering wire through the process zone to the newly solidified solder joint. The camera unit 3 is moved simultaneously with the machining laser beam so that the image section 9 moves over the surface region 8 accordingly and the image sections 9 of the image frames 6 at least partially overlap. For this purpose, the frame rate of the camera unit 3 and the speed at which the processing laser and the camera unit 3 are moved are matched accordingly. In one form, at typical processing speeds, the frame rate can be 100 frames per second.

As already mentioned, the camera unit 3 is configured and designed to capture an image sequence 5 consisting of a plurality of consecutive image frames 6 of the surface region 8 to be evaluated. This image sequence 5 is transmitted to a data processing unit 1 of the apparatus 200. Therefore, the camera unit 3 and the data processing unit 1 are operatively connected for signal communication.

The data processing unit 1 is used to process the image frames 6 of the image sequence 5 in order to identify the occurrence of a defect 7 and if a defect 7 is present, to determine its size. For this purpose, the data processing unit 1 has a trained neural network 2, by means of which the image frames 6 are assigned to two image classes 10a, 10b. In this case, image frames 6 recognized as “ok” are assigned to the first image class 10a and image frames 6 recognized as “defective” are assigned to the defect image class 10b.

The trained neural network 2 in one form is a neural network that has been trained by means of transfer learning. The trained neural network 2 is based on the pre-trained neural network designated as “ResNet50”, which was described earlier. This pre-trained neural network was further trained with 40 image sequences 5 acquired during a laser beam soldering process, in which the image sequences 5 contained a total of 400 image frames 6 in which the assignment to the image classes 10a, 10b was specified. Using this additional training process, a trained neural network 2 was created that is capable of detecting surface defects such as pores, holes, spatter, but also device defects, such as a defective protective glass of the soldering optics, on image frames 6.

The data processing unit 1 is also designed and configured to check whether multiple image frames 6 of a specifiable number of directly consecutive image frames 6 in the image sequence 5 have been assigned to the defect image class 10b. In one form, four directly consecutive image frames 6 in the image sequence 5 are checked to determine whether all four image frames 6 were assigned to the defect image class 10b. This specification can be varied depending on the accuracy desired. If all four of the four directly consecutive image frames 6 have been assigned to the defect image class 10b, a defect signal 11 is output.

The defect signal 11 causes a You Only Look Once style (YOLO-style) model 12 to be activated in a subsequent method step. The YOLO-style model 12 is used to determine the size of the previously detected defect 7. To this end, the YOLO-style model 12 was trained with the same training data as the trained neural network 2.

In one form, the apparatus 200 described above can be used to carry out the following method 100, which is elucidated with reference to FIG. 1.

The method 100 is used to identify, in a computer-implemented manner, the occurrence of defects 7 during the laser soldering process. In addition, the size of the defects 7 that occurred is determined.

After the start of the method 100, in method step S1 an image sequence 5 is acquired containing a plurality of image frames 6 of the surface region 8 to be evaluated. The image is acquired at a frame rate of 100 frames per second. Different frame rates are possible. The image section 9 of each image frame 6 is selected in such a way that the image sections 9 of the image frames 6 partially overlap. In one form, an overlap of 80% can be provided, i.e., in two directly consecutive frames 6, the image section 9 is 80% identical. During the acquisition of the image sequence 5, the image section 9, or the camera unit 3 that images the image section 9, is moved together with the surface modification device 4.

In method step S2, the image sequence 5 is submitted for further processing, e.g., transmitted from the camera unit 3 to the data processing unit 1. In parallel, the trained neural network 2 is provided in method step S3.

In the method step S4, the image frames 6 of the image sequence 5 are assigned to the two image classes 10a, 10b by means of the trained neural network 2, i.e., a decision is made as to whether the image frame 6 to be assigned shows a defect 7 or not. In the first case, the image is assigned to the defect image class 10b, otherwise to the other image class 10a.

In the subsequent method step S5, it is checked whether multiple image frames of a specifiable number of directly consecutive image frames 6 in the image sequence 5 have been assigned to the defect image class 10b. As already mentioned, in one form, four directly consecutive image frames 6 in the image sequence 5 are checked to determine whether all four image frames 6 were assigned to the defect image class 10b.

If this is the case, the method 100 continues to method step S6, in which a defect signal 11 is output. If four directly consecutive image frames 6 have not been assigned to the defect image class 10b, the method 100 returns to method step S1.

The defect signal 11 output in method step S6 serves as a trigger signal or starting signal for the subsequent method step S7. In method step S7, the size of the defect 7 is determined using a YOLO-style model 12. In one form, the defect 7 can be classified according to whether the size of the defect 7 is very small, small, or large. Very small can mean, in one form that no further measures need to be taken and that the corresponding component can be further processed in the same way as functional components. Small can mean that the defect 7 can be repaired, e.g., by polishing the corresponding surface region of the component concerned. Large can mean that the defect 7 cannot be repaired and the component in question must be rejected. After method step S7, the method 100 ends.

Of course, deviations from this form of the method 100 are possible. Thus, it can be provided that the method 100 is not terminated after method step S7, but also returns to method step 51 thereafter. It is advantageous to carry out the method 100 in real time during the laser soldering process, wherein the individual method steps 51 to S7 can overlap in time. This means that while the image frames 6 that are currently being acquired are assigned to the image classes 10a, 10b, further image frames 6 are acquired, etcetera.

By evaluating the surface region 8 not only on the basis of a single image frame 6, but by using successive image frames 6 as temporal data, it is possible to observe whether a suspected or actual defect 7 “is traveling through the camera image”. Only if this is the case, i.e., if the defect 7 can be detected on multiple image frames 6, is an actual defect 7 assumed. This can significantly increase the reliability of the defect prediction compared to a conventional automated quality assurance, as fewer false-positive and false-negative defects 7 are identified. Compared to visual inspection, the proposed method 100 has the advantage, in addition to a reduced personnel requirement and associated cost savings, that even small defects 7 that are not visible to the naked eye can be identified. Thus, the overall quality of the surface-treated components can be increased, as components of low quality can be rejected or process parameters and/or parts of the apparatus can be altered such that the detected defects 7 no longer occur.

By determining the size of the defect 7 in a method step S7 that is separate from the method steps S1 to S6 and, consequently, the size is not determined for every image frame 6 but only for defects 7 that have already been detected, the method 100 overall can be carried out at high speed, in particular in real time, even for processes with high component throughput, while at the same time provides high reliability in the defect identification and size determination. This contributes to further increase of the quality assurance.

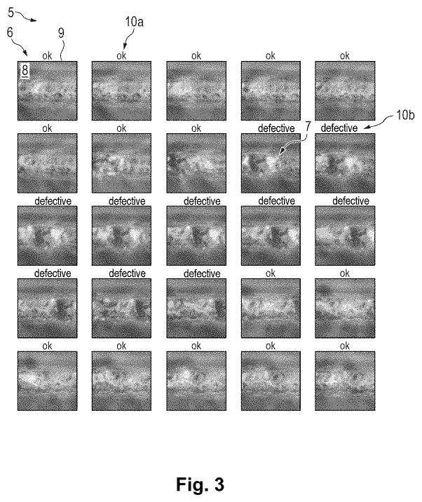

FIG. 3 shows an example image sequence 5 of a surface region 8 of a component to be evaluated, the surface of which is treated by means of a laser soldering process. The image sequence 5 comprises 25 image frames 6, the image sections 9 of which partially overlap. The image frames 6 were acquired by the camera unit 3 in the sequence from top left to bottom right and transferred to the data processing unit 1 of the apparatus 200 for evaluation.

By means of the trained neural network 2 of the data processing unit 1, the image frames 6 were each assigned to an image class 10a, 10b, as can be seen in FIG. 3 on the basis of the classification as “ok” or “defective”. The first eight frames 6 were classified as “ok” and thus assigned to the first image class 10a. These are followed by twelve image frames 6, which were classified as “defective” and thus assigned to the defect image class 10b. These are followed by seven image frames 6, which were again classified as “ok” and assigned to image class 10a.

In the image frames 6 assigned to the defect image class 10b, a pore can be identified as the defect 7. This defect 7 travels across the image section 9 as a result of the movement of the camera unit 3 together with the surface processing device 4 from left to right.

To be able to detect the defect 7 reliably with a high probability, a check is carried out, in one form, to determine whether four directly consecutive image frames 6 have been assigned to the defect image class 10b. This is the case with the image sequence shown in FIG. 3, since a total of twelve (12) directly consecutive image frames 6 have been assigned to the defect image class 10b. As a result, it can be concluded with a high probability that a defect 7 is actually present and so a defect signal 11 is output. The defect signal 11 can, in one form, interrupt the surface modification process in order to allow the faulty component to be removed from the production process. Alternatively, the production process can continue and the component in question will be removed after completion of its surface modification, or visually inspected as a further check.

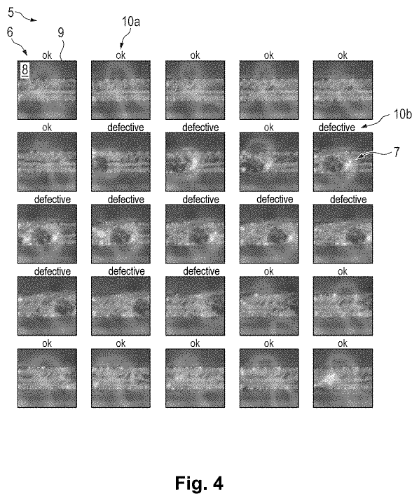

FIG. 4 shows another form image sequence 5 of a surface region 8 of a component to be evaluated, the surface of which is treated by means of a laser soldering process. The image sequence 5 again comprises 25 a plurality of image frames 6, the image sections 9 of which partially overlap. As in FIG. 3, the image frames 6 were acquired by the camera unit 3 in the sequence from top left to bottom right and transferred to the data processing unit 1 of the apparatus 200 for evaluation.

By means of the trained neural network 2 of the data processing unit 1, the image frames 6 were each assigned to an image class 10a, 10b, as can be seen in FIG. 4 on the basis of the classification as “ok” or “defective”. In this case, the first six image frames 6 were classified as “ok” and thus assigned to the first image class 10a, two image frames 6 that were classified as “defective”, one image frame 6 that was classified as “ok”, nine image frames 6 that were classified as “defective”, and a further seven frames 6 that were classified as “ok”. In other words, with the exception of a single image frame 6, twelve directly consecutive frames 6 were assigned to the defect image class 10b.

In the image frames 6 assigned to defect image class 10b, a pore can be identified as the defect 7. This defect 7 travels across the image section 9 as a result of the movement of the camera unit 3 together with the surface processing device 4 from left to right.

To be able to detect the defect 7 reliably with a high probability, a check is carried out, in one form, to determine whether four directly consecutive image frames 6 have been assigned to the defect image class 10b. This is the case with the image sequence shown in FIG. 4, since a total of nine directly consecutive image frames 6, i.e., the 10th to the 18th image frame, have been assigned to the defect image class 10b. As a result, it can be concluded with a high probability that a defect 7 is actually present and so a defect signal 11 is output.

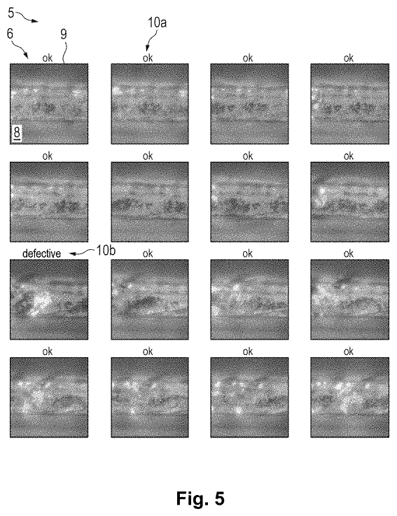

FIG. 5 shows another example image sequence 5 of a surface region 8 of a component to be evaluated, the surface of which is treated by means of a laser soldering process. The image sequence 5 comprises 20 image frames 6, the image sections 9 of which partially overlap. As in FIG. 3, the image frames 6 were acquired by the camera unit 3 in the sequence from top left to bottom right and transferred to the data processing unit 1 of the apparatus 200 for evaluation.

By means of the trained neural network 2 of the data processing unit 1, the image frames 6 were each assigned to an image class 10a, 10b, as can be seen in FIG. 5 on the basis of the classification as “ok” or “defective”. The first eight image frames 6 have been classified as “ok” and thus assigned to the first image class 10a. The ninth image frame 6 was classified as “defective”. The other image frames were again classified as “ok”.

However, the image frame 6 classified as “defective” is an incorrect classification, since this image frame 6 does not actually show a defect 7. If each image frame 6 alone were used for predicting defects independently of the other image frames 6, this incorrectly classified image frame 6 would trigger the output of a defect signal 11 and possibly stop component production.

However, as the proposed method provides a check of whether multiple image frames 6 of a specifiable number of directly consecutive image frames 6 in the image sequence 5 have been assigned to the defect image class 10b, when the proposed method is used no defect signal 11 is output, since only a single image frame 6 was assigned to the defect image class 10b. The detection of false-positive defects 7 can thus be avoided.

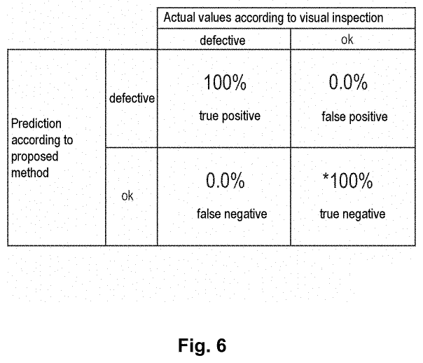

FIG. 6 shows an illustration of the prediction accuracy of defects 7 by means of the above-described method 100 compared to a visual inspection, which has been standard practice up to now. The surface region 8 of 201 components was analyzed, i.e., 201 components were surface treated using a laser soldering process.

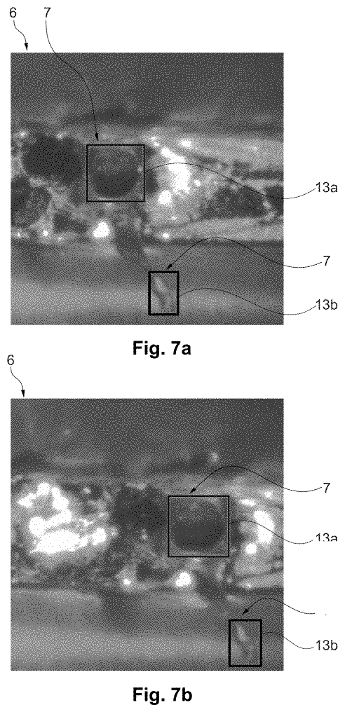

From the diagram, it is apparent that 100% of the components identified as “defective” by visual inspection were also identified as “defective” by means of the proposed method (category “true positive”). None of the components identified as “ok” by visual inspection were identified as “defective” by means of the proposed method (category “false positive”). Similarly, none of the components identified as “defective” by visual inspection were identified as “ok” by means of the proposed method (category “false negative”). Again, 100% of the components identified as “ok” by visual inspection were identified as “ok” by the proposed method (category “true negative”), where the asterisk “*” in FIG. 7 indicates that an actual defect 7 was correctly identified by means of the proposed method, but not during the standard manual visual inspection. The defect 7 was so small that it was no longer visible after the downstream surface polishing process. A subsequent manual analysis of the process video showed that the defect 7 was actually a very small pore.

The existence of the defect 7 could only be confirmed by further investigations. Consequently, it can be concluded that the proposed method 100 not only achieves, but can even exceed, the accuracy of the surface quality assessment of the visual inspection that is currently normally used, i.e., it also detects defects 7 which are not detectable by standard visual inspection.

FIGS. 7a and 7b show two consecutive image frames 6 with two defects 7. The associated object bounding boxes 13 can also be seen, which are used to determine the size of the defects 7 using the YOLO-style model. The object frame 13a encloses a pore in the solder joint. The object frame 13b encloses a solder spatter adhering to the outer sheet next to the solder joint. Based on the size of the object frames 13a, 13b, the size of the individual defects 7 can be determined and it can thus be ascertained whether reworking is necessary.

In summary, the disclosure offers the following main advantages:

Even very small defects 7 can be detected, which means that a visual inspection of the surface region 8 of the component after the completion of the surface modification process is not necessary.

The size determination can be carried out reliably and with high accuracy, since for the size determination only those image frames 6 that show a defect 7 according to the defect identification are examined, and therefore more computational resources are available for the size determination.

The defect identification and size determination can be carried out in real time, i.e., making a downstream quality control process unnecessary.

The predictive accuracy is significantly better than previous methods, i.e., there are fewer false-positive or false-negative results.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A computer-implemented method for determining a size of a defect occurring in a surface region of a component while a surface modification process is performed on the surface region, the method comprising:
identifying an occurrence of a defect occurring at a surface region of a component based on a set of images; and
determining a size of the defect identified at the surface region in response to the occurrence of the defect being identified.

2. The method according to claim 1, wherein the size of the defect is determined using a You Only Look Once style (YOLO-style) model.

3. The method according to claim 1, wherein the identifying the occurrence of the defect based on the set of images further comprises:
providing an image sequence comprising a plurality of image frames of the surface region to be evaluated, each image frame showing an image section of the surface region and with a plurality of image sections of the plurality of image frames at least partially overlapping one another;
assigning the plurality of image frames to at least one of at least two image classes, of which at least one image class is a defect image class having a defective attribute;
checking whether multiple image frames of a specifiable number of directly consecutive image frames in the image sequence have been assigned to the defect image class; and
outputting a defect signal when the multiple image frames of the specifiable number of directly consecutive image frames have been assigned to the defect image class.

4. The method according to claim 3 further comprising providing a trained neural network, wherein the plurality of image frames is assigned to the image classes by the trained neural network.

5. The method according to claim 3 further comprising recording the image sequence of the surface region to be evaluated, wherein a rate of recording the image sequence is faster than a rate of determining the size of the defect.

6. The method according to claim 3, wherein the image section of each of the plurality of image frames is moved together with a surface modification device for carrying out the surface modification process.

7. The method according to claim 4, wherein:
the size of the defect is determined using a You Only Look Once style (YOLO-style) model, and
the YOLO-style model has been trained with the same training data as the trained neural network.

8. The method according to claim 3, wherein the determining the size of the defect is based on the defect signal being output.

9. An apparatus for determining a size of a defect occurring in a surface region of a component while a surface modification process is performed on the surface region, the apparatus comprising one or more processors and one or more non-transitory computer-readable mediums storing instructions that are executable by the one or more processors, wherein the one or more processors operate as:
a data processing unit that is configured to:
identify an occurrence of a defect occurring at a surface region of a component based on a set of images; and
determine a size of the defect in response to the occurrence of the defect being identified.

10. The apparatus according to claim 9, wherein the data processing unit is configured to determine the size of the defect using a You Only Look Once style (YOLO-style) model.

11. The apparatus according to claim 9, wherein to identify the occurrence of the defect based on the set of images, the data processing unit is configured to:
assign one or more image frames of an image sequence comprising a plurality of image frames of the surface region to be evaluated to at least one image class of at least two image classes, each image frame showing an image section of the surface region and with a plurality of image sections of the plurality of image frames at least partially overlapping one another, and wherein at least one image class is a defect image class having a defective attribute;
check whether multiple image frames of a specifiable number of directly consecutive image frames in the image sequence have been assigned to the defect image class; and
output a defect signal when the multiple image frames of the specifiable number of directly consecutive image frames have been assigned to the defect image class.

12. The apparatus according to claim 11, wherein the data processing unit comprises a trained neural network for assigning each of the plurality of image frames to the least one of the at least two image classes.

13. The apparatus according to claim 12, wherein:
the size of the defect is determined using a You Only Look Once style (YOLO-style) model, and
the YOLO-style model has been trained with the same training data as the trained neural network.

14. The apparatus according to claim 11 further comprising:
a camera configured to capture the image sequence comprising the plurality of image frames of the surface region to be evaluated, wherein a rate of capturing the image sequence is faster than a rate of determining the size of the defect.

15. The apparatus according to claim 9 further comprising a surface modification device configured to modify surface of the surface region of the component.

16. A computer program for determining a size of a defect occurring in a surface region of a component while a surface modification process is performed on the surface region, the computer program stored in a non-transitory recording medium and including one or more commands executable by one or more processors, the one or more commands comprise:
identifying an occurrence of a defect occurring in a surface region of a component based on a set of images; and
determine a size of the defect after the occurrence of the defect is identified.

17. The computer program according to claim 16, wherein the one or more commands further comprise:
assigning one or more image frames of an image sequence comprising a plurality of image frames of the surface region to be evaluated to at one of at least two image classes, each image frame showing an image section of the surface region and with a plurality of image sections of the plurality of image frames at least partially overlapping one another, and wherein at least one image class is a defect image class having a defective attribute;
checking whether multiple image frames of a specifiable number of directly consecutive image frames in the image sequence have been assigned to the defect image class; and
outputting a defect signal when the multiple image frames of the specifiable number of directly consecutive image frames have been assigned to the defect image class.

18. The computer program according to claim 16, wherein the size of the defect is determined using a You Only Look Once style (YOLO-style) model.

19. The computer program according to claim 17, wherein the image frames are assigned to the at least one of the at least two image classes via a trained neural network.

20. A computer readable data carrier, on which the computer program according to claim 16 is stored or transmits the computer program.
